(19) United States
(12) Patent Application Publication
(10) Pub. No.: US 2012/0195048 A1
(43) Pub. Date: Aug. 2, 2012

(54) Light device having LED light member

(76) Inventors: Ta-Feng Chiu, Zinbei City (TW); Chin-Hsien Liu, Zinbei City (TW)

(21) Appl. No.: 12/931,452

(22) Filed: Feb. 1, 2011

(51) Int. Cl. F21V 29/00

(52) U.S. Cl. 362/294

(57) ABSTRACT

A light device includes an arm having a hosing supported on a free end, a light emitting diode (LED) located distal to the housing for generating a light, a heat dissipating device located close to the LED for dissipating a heat generated by the LED, and a light refractive member engaged into the arm and having one end portion located close to the LED for receiving the light generated by the LED and having another end portion extended into the housing for directing the light out through the housing. The arm is supported on a supporting base, and the LED and the heat dissipating device are disposed in the supporting base.

### BACKGROUND OF THE INVENTION

1. Field of the Invention

The present invention relates to a light device, and more particularly to a light device including one or more light generating members, such as light emitting diodes (LEDs) for generating lights, and a light refractive member for refracting the light toward a light carrier, and a heat dissipating device disposed close to the light generating members, but distal to the light refracting member.

2. Description of the Prior Art

Typical light devices comprise a lamp holder or carrier disposed or supported above a stand or supporting base with one or more arms or supporting rods, and one or more light generating members, such as light emitting diodes (LEDs), light bulbs or the other light members to be disposed or attached or mounted or engaged into the lamp holder or carrier for generating lights and for supplying the lights to the users.

For example, U.S. Pat. No. 5,050,054 to Hsu discloses one of the typical illumination apparatuses and comprises an adjustable lamp support mounted on a stand or supporting base with one or more arms or supporting rods for holding or supplying a lamp holder or carrier which may be used to engage or support one or more light generating members, such as light emitting diodes (LEDs), light bulbs or the other light members.

Normally, when the light emitting diodes (LEDs) are disposed or attached or mounted or engaged into the lamp holder or carrier, an additional heat dissipating device should be provided and disposed close to the light generating members for dissipating the heat that may be generated by the light generating members.

However, when both the light generating members or light emitting diodes (LEDs) and the heat dissipating device are disposed or attached or mounted or engaged into the lamp holder or carrier, the lamp holder or carrier should include a greatly increased volume to receive or accommodate the parts or elements, and the weight of the lamp holder or carrier and the heat dissipating device and the light generating members may also be greatly increased.

U.S. Pat. No. 4,241,281 to Morimoto et al., U.S. Pat. No. 4,703,219 to Mesquida, and U.S. Pat. No. 5,187,547 to Niina et al. disclose several of the typical illumination apparatuses or light emitting diode display devices and comprise one or more light emitting diode elements for generating lights.

However, one or more additional heat dissipating devices should be provided and disposed close to the light generating members or LEDs for dissipating the heat that may be generated by the light generating members or LEDs and for preventing the light generating members or LEDs from being over-heated.

The present invention has arisen to mitigate and/or obviate the afore-described disadvantages of the conventional light devices having light emitting diodes.

### SUMMARY OF THE INVENTION

The primary objective of the present invention is to provide a light device including one or more light generating members, such as light emitting diodes (LEDs) for generating lights, and a light refractive member for refracting the light toward a light carrier, and a heat dissipating device disposed close to the light generating members, but disposed distal to the light refracting member.

In accordance with one aspect of the invention, there is provided a light device comprising an arm including a first end, and including a second end, and including a hosing provided and supported on the second end of the arm, a light emitting diode (LED) located distal to the housing for generating a light, a heat dissipating device located close to the light emitting diode (LED) for dissipating a heat generated by the light emitting diode (LED), and a light refractive member engaged into the arm and including a first end portion disposed and located close to the light emitting diode (LED) for receiving the light generated by the light emitting diode (LED), and including a second end portion extended into the housing for directing the light out through the housing.

The first end of the arm is supported on a supporting base, and the light emitting diode (LED) and the heat dissipating device are disposed in the supporting base. A power supply may further be provided and disposed in the supporting base and electrically connected to the light emitting diode (LED) for energizing the light emitting diode (LED). The housing includes a lower covering arranged for allowing the light to emit out through the lower covering of the housing.

The housing includes a panel having an orifice formed therein for allowing the light to emit out through the orifice of the panel. The second end portion of the light refractive member is extended toward the orifice of the panel. The panel includes a lens mounted in the orifice of the panel. The second end portion of the light refractive member includes a protrusion extended and engaged into the orifice of the panel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a light device in accordance with the present invention;

FIG. 2 is a block diagram illustrating the parts or elements of the light device;

FIG. 3 is another partial cross sectional view, similar to FIG. 1, illustrating the operation of the light device;

FIG. 4 is a further partial cross sectional view similar to FIGS. 1 and 3, illustrating the other arrangement of the light device; and

FIG. 5 is an enlarged partial cross sectional view of the light device.

### DETAILED DESCRIPTION OF THE PREFERRED EMBODIMENT

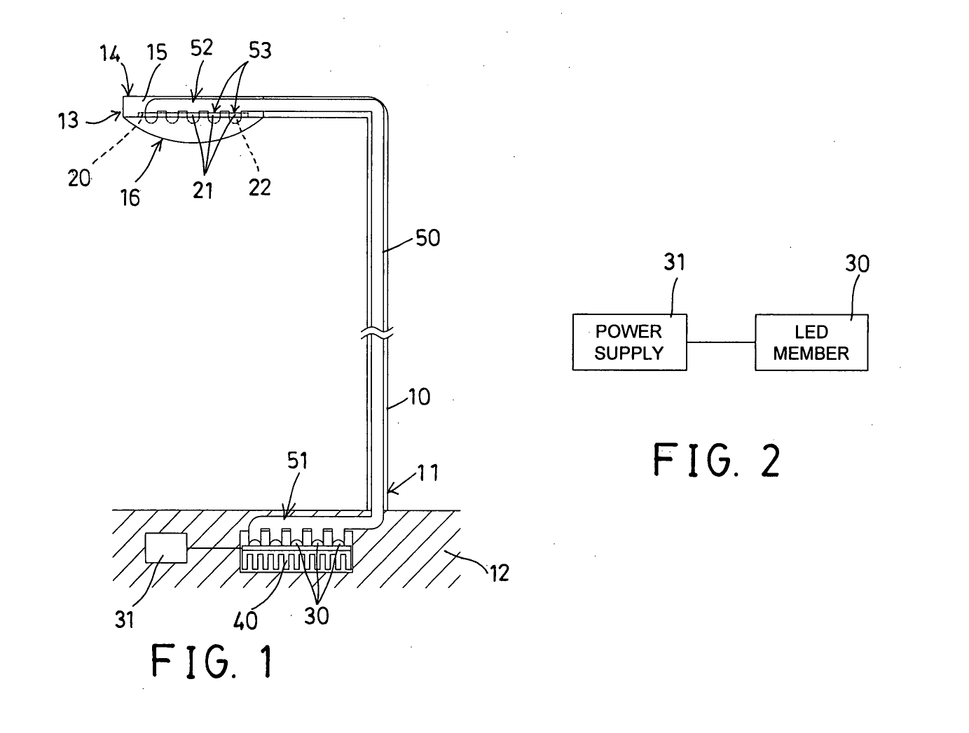

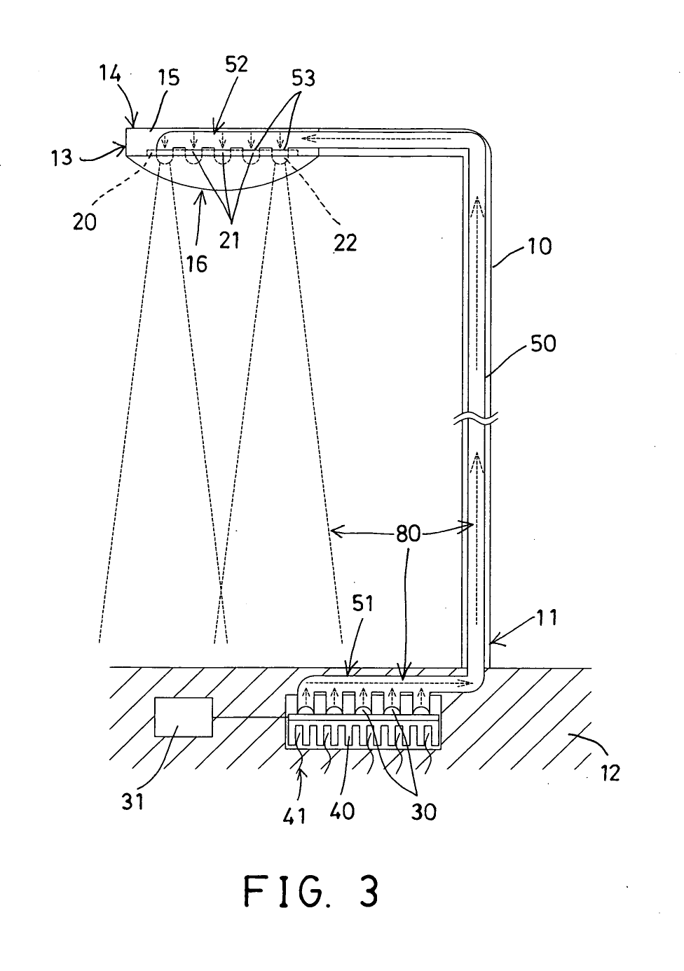

Referring to the drawings, and initially to FIGS. 1 and 2, a light device in accordance with the present invention comprises a supporting rod or arm 10 including one or first or lower end 11 disposed or supported above a stand or supporting base 12, and including a lamp holder or carrier 14 disposed or formed or provided or supported on the other end or second or upper end or portion 13 of the arm 10. For example, the carrier 14 includes a receptacle or housing 15 formed or provided or supported on the other or upper end or portion 13 of the arm 10, and a lens or cover or cap or hood or lampshade or covering 16 disposed or formed or provided or supported on the lower portion of the housing 15 and made of transparent or semi-transparent materials for allowing the light 80 (FIG. 3) to be emitted out through the covering 16.

The carrier 14 includes a light emitting area or bracket or panel 20 disposed or mounted or engaged or supported in the housing 15, and the panel 20 includes one or more apertures or openings or orifices 21 formed therein, and a lens 22 disposed or attached or mounted or engaged into the respective orifice 21 of the panel 20 and arranged for allowing the light 80 to be emitted out through the lens 22. One or more light generating members 30, such as light emitting diodes (LEDs) 30 are disposed or attached or mounted or engaged into the stand or supporting base 12 and located distal to the housing 15 and the covering 16 of the carrier 14, and a power source or power supply 31, such as one or more batteries 31 will also be disposed or attached or mounted or engaged into the stand or supporting base 12 and electrically connected or coupled to the LEDs 30 for energizing the LEDs 30.

The light emitting diodes (LEDs) 30 are provided for generating the light 80, when energized by the power supply 31, and for allowing the light 80 to be emitted or transmitted toward the housing 15 or the panel 20 or the lens 22, as best shown in FIG. 3. The light device further includes a heat dissipating device 40 also disposed or attached or mounted or engaged into the stand or supporting base 12 and disposed or located beside or below or close to the light emitting diodes (LEDs) 30 for dissipating the heat 41 that may be generated by the light emitting diodes (LEDs) 30 when the light emitting diodes (LEDs) 30 are energized or actuated or operated by the power supply 31. It is to be noted that the light emitting diodes (LEDs) 30 and the heat dissipating device 40 are disposed or located distal to the housing 15 or the panel 20 or the lens 22, and the heat dissipating device 40 may be selected from heat dissipating fans or fins, or air or water cooling facilities or apparatuses.

The light device further includes a light refractive member 50 disposed or attached or mounted or engaged into the arm 10, and the light refractive member 50 includes one or first or lower end portion 51 disposed or located beside or below or close to the light emitting diodes (LEDs) 30 for receiving the light 80 generated by the light emitting diodes (LEDs) 30, and includes another end or second or upper end portion 52 extended into the housing 15 and selectively includes one or more projections or protrusions 53 extended from the other or upper end or portion 52 of the light refractive member 50 and disposed or engaged into the orifices 21 of the panel 20 and for directing the light 80 toward the panel 20 or the lens 22.

In operation, as shown in FIG. 3, the light 80 generated by the light emitting diodes (LEDs) 30 may be emitted or transmitted toward the one end portion 51 of the light refractive member 50, and the light refractive member 50 may then refract or transmit the light 80 toward the other or upper end or portion 52 of the light refractive member 50 and then toward the panel 20 or the lens 22 for allowing the light 80 to be emitted out through the lens 22. The heat dissipating device 40 is disposed close to the light emitting diodes (LEDs) 30 for dissipating the heat 41 that may be generated by the light emitting diodes (LEDs) 30. It is also to be noted that the light emitting diodes (LEDs) 30 and the heat dissipating device 40 are disposed or located distal to the housing 15 or the panel 20 or the lens 22 such that the housing 15 is not required to carry or receive or accommodate or support the light emitting diodes (LEDs) 30 and the heat dissipating device 40 and may include a greatly decreased or reduced size or dimension or volume and weight.

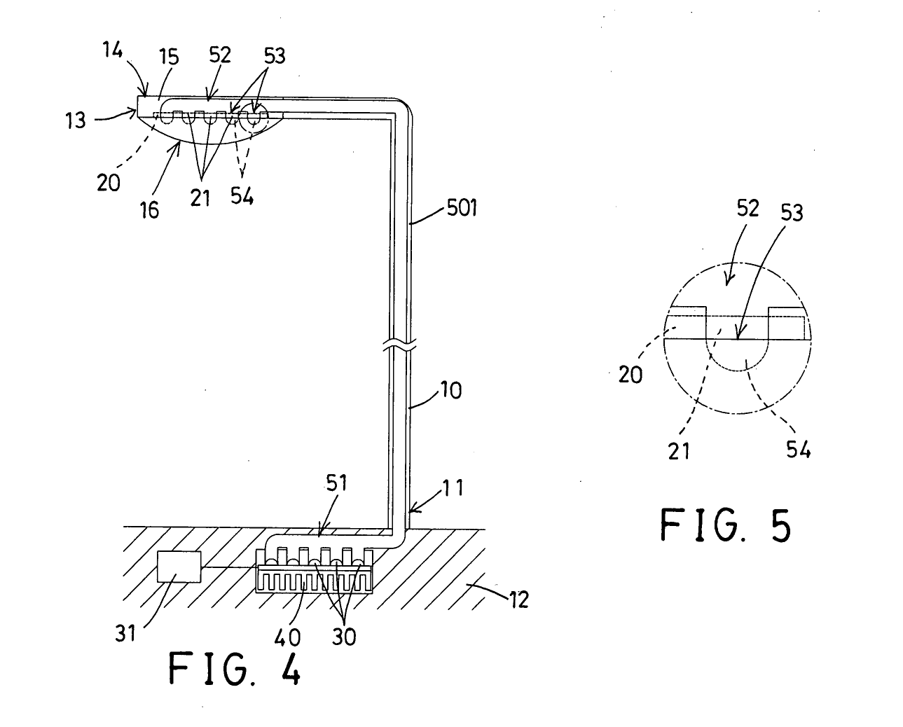

Alternatively, as shown in FIGS. 4 and 5, the light refractive member 501 may include a lens 54 that may be optionally or directly disposed or attached or mounted or secured or coupled to the protrusion 53 or the other or upper end or portion 52 of the light refractive member 50, instead of disposed or attached or mounted or engaged into the respective orifice 21 of the panel 20 as that shown in FIGS. 1 and 3, for suitably directing the light 80 toward or out through the lens 54.

Accordingly, the light device in accordance with the present invention includes one or more light generating members, such as light emitting diodes (LEDs) for generating lights, and a light refractive member for refracting the light toward a light carrier, and a heat dissipating device disposed close to the light generating members, but disposed distal to the light refracting member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
an arm including a first end, and including a second end, and including a hosing provided and supported on said second end of said arm,
a light emitting diode (LED) located distal to said housing for generating a light,
a heat dissipating device located close to said light emitting diode (LED) for dissipating a heat generated by said light emitting diode (LED), and
a light refractive member engaged into said arm and including a first end portion disposed and located close to said light emitting diode (LED) for receiving the light generated by said light emitting diode (LED), and including a second end portion extended into said housing for directing the light out through said housing.

2. The light device as claimed in claim 1, wherein said first end of said arm is supported on a supporting base, and said light emitting diode (LED) and said heat dissipating device are disposed in said supporting base.

3. The light device as claimed in claim 2 further comprising a power supply disposed in said supporting base and electrically connected to said light emitting diode (LED) for energizing said light emitting diode (LED).

4. The light device as claimed in claim 1, wherein said housing includes a lower covering arranged for allowing the light to emit out through said lower covering of said housing.

5. The light device as claimed in claim 1, wherein said housing includes a panel having an orifice formed therein for allowing the light to emit out through said orifice of said panel.

6. The light device as claimed in claim 5, wherein said second end portion of said light refractive member is extended toward said orifice of said panel.

7. The light device as claimed in claim 5, wherein said panel includes a lens mounted in said orifice of said panel.

8. The light device as claimed in claim 5, wherein said second end portion of said light refractive member includes a protrusion extended and engaged into said orifice of said panel.
